(19) United States
(12) Patent Application Publication
(10) Pub. No.: US 2003/0180607 A1
(43) Pub. Date: Sep. 25, 2003

(54) Zinc alloy powder for alkaline manganese dioxide cell, and negative electrode for alkaline manganese dioxide cell, and alkaline manganese dioxide cell using same

(76) Inventors: Masamoto Sasaki, Saitama-shi (JP); Shigeo Hirayama, Hiroshima (JP); Akira Oyama, Shimonoseki-shi (JP); Seiji Fuchino, Shimonoseki-shi (JP); Mitsuo Shinoda, Shimonoseki-shi (JP); Tadayoshi Odawara, Shimonoseki-shi (JP); Kouji Morita, Shimonoseki-shi (JP)

Correspondence Address: MUSERLIAN AND LUCAS AND MERCANTI, LLP, 600 THIRD AVENUE, NEW YORK, NY, 10016, US

(21) Appl. No.: 10/378,697

(22) Filed: Mar. 4, 2003

(30) Foreign Application Priority Data
Mar. 5, 2002 (JP) 2002-58290
Apr. 24, 2002 (JP) 2002-122299
Apr. 24, 2002 (JP) 2002-122300
Apr. 24, 2002 (JP) 2002-122301
Apr. 24, 2002 (JP) 2002-122302
Nov. 27, 2002 (JP) 2002-343589

(51) Int. Cl. H01M 4/00; H01M 6/00

(52) U.S. Cl. 429/128

(57) ABSTRACT

A zinc alloy powder for an alkaline manganese dioxide cell, in which the average concentration of an iron component in the zinc alloy powder is 5 ppm or less, the average concentration of the iron component within a near-surface portion of the zinc alloy powder is 10 ppm or less, and the total content of the iron component in impurities present at the near-surface portion of the zinc alloy powder is 0.5 ppm or less based on the whole body of the particles, can easily suppress abnormal generation of gas at a low cost.

The entire disclosure of Japanese Patent Application No. 2002-058290 filed on Mar. 5, 2002, Japanese Patent Application Nos. 2002-122299, 2002-122300, 2002-122301 and 2002-122302, all filed on Apr. 24, 2002, and Japanese Patent Application No. 2002-343589 filed on Nov. 27, 2002, including specification, claims, drawings and summary is incorporated herein by reference in its entirety.

### BACKGROUND OF THE INVENTION

1. Field of the Invention

This invention relates to a zinc alloy powder for an alkaline manganese dioxide cell, and a negative electrode for an alkaline manganese dioxide cell, and an alkaline manganese dioxide cell which use the zinc alloy powder. More specifically, the invention relates to a zinc alloy powder for a mercury-free alkaline manganese dioxide cell which suppresses the generation of hydrogen gas and has increased the electrolyte leakage resistance (corrosion resistance) of the cell, and a negative electrode for an alkaline manganese dioxide cell, and an alkaline manganese dioxide cell which use the zinc alloy powder.

2. Description of the Related Art

In 1992, Japan became the first country to dispel mercury completely from a zinc powder for use as an active material of a negative electrode of an alkaline manganese dioxide cell to put a mercury-free alkaline manganese dioxide cell into commercialization. Innovative techniques, which contributed greatly to the perfection of this technique unaccomplished for many years, and aided in subsequent worldwide spread of mercury-free batteries, are proposed in documents 1 to 3 listed below. The core of these techniques lies in using a zinc alloy powder as an active material of a negative electrode of an alkaline manganese dioxide cell. The zinc alloy powder has been produced by alloying while decreasing iron, an impurity commonly present in the environment, to a low level of 1 ppm or less, and adding a specific element.

Document 1: Japanese Patent Publication No. 1995-054704

Document 2: U.S. Pat. No. 5,108,494

Document 3: European Patent 0500313

Based on the above techniques, subsequent alkaline manganese dioxide cells have been produced to date widely all over the world, but have commercially posed the following problems:

(1) To keep iron in the zinc alloy powder at 1 ppm or less, as in the above-mentioned documents 1 to 3, a zinc metal with a very high purity, whose iron concentration has been decreased to 1 ppm or less, needs to be used as a starting material. The use of such a highly pure zinc metal is not industrially impossible, but its acquisition is considerably restricted, because strict management of manufacturing facilities and the manufacturing process is required.

(2) If a zinc metal or zinc alloy powder with an iron concentration of 2 ppm or more is used, on the other hand, abnormal generation of gas or electrolyte leakage occurs with a certain probability in an alkaline manganese dioxide cell produced.

(3) Even in an alkaline manganese dioxide cell using a zinc metal or zinc alloy powder of a very high purity, as in the above-mentioned documents 1 to 3, a large amount of gas occurred very rarely.

### SUMMARY OF THE INVENTION

The present invention has been accomplished in an attempt to solve the problems with the earlier technologies. Its object is to provide a zinc alloy powder for a mercury-free alkaline manganese dioxide cell, which can easily suppress abnormal gas generation at a low cost, and eventually improve the electrolyte leakage resistance (corrosion resistance) of the mercury-free alkaline manganese dioxide cell.

The present inventors conducted in depth studies in order to solve the aforesaid problems. As a result, they found that even if the concentration of the iron component in the zinc alloy powder is as high as 5 ppm, the above objects can be attained by keeping the average concentration of the iron component within a near-surface portion of the zinc alloy powder, and the total content of the iron component in impurities present at the near-surface portion of the zinc alloy powder, down to predetermined values or lower. This finding led them to accomplish the present invention.

They also found that even if the concentration of iron in the zinc alloy powder is as high as 5 ppm, the above objects can be attained by decreasing incidental trace impurities, especially, trace impurities such as Ge, As and Sb, to predetermined concentrations or lower. This finding also led them into accomplishing the present invention.

They also found that the above objects can be attained by incorporating specific trace additive elements and bringing the powder size distribution of the zinc alloy powder into predetermined ranges. This finding also led them to accomplish the present invention.

A first aspect of the invention, based on such findings, is a zinc alloy powder for an alkaline manganese dioxide cell in which the average concentration of an iron component in the zinc alloy powder is 5 ppm or less, the average concentration of the iron component within a near-surface portion of the zinc alloy powder is 10 ppm or less, and the total content of the iron component in impurities present at the near-surface portion of the zinc alloy powder is 0.5 ppm or less based on the whole body of particles.

A second aspect of the invention is the zinc alloy powder for the alkaline manganese dioxide cell according to the first aspect of the invention in which the average concentration of iron in the zinc alloy powder exceeds 1 ppm, but is not more than 5 ppm.

A third aspect of the invention is the zinc alloy powder for the alkaline manganese dioxide cell according to the first or second aspect of the invention, which contains 10 to 10,000 ppm each of one or more elements selected from the group consisting of Al, Bi, Ca, In, Pb, Mg and Sn.

A fourth aspect of the invention is a zinc alloy powder for an alkaline manganese dioxide cell in which the average concentration of an iron component in the zinc alloy powder is 5 ppm or less, the average concentration of a Ge component is 20 ppb or less, the average concentration of an As component is 5 ppb or less, and the average concentration of an Sb component is 50 ppb or less.

A fifth aspect of the invention is a zinc alloy powder for an alkaline manganese dioxide cell in which the average concentration of an iron component in the zinc alloy powder is 5 ppm or less, the average concentration of a Ge component is 1 ppb or less, the average concentration of an As component is 5 ppb or less, and the average concentration of an Sb component is 80 ppb or less.

A sixth aspect of the invention is a zinc alloy powder for an alkaline manganese dioxide cell in which the average concentration of an iron component in the zinc alloy powder is 5 ppm or less, the average concentration of a Ge component is 20 ppb or less, the average concentration of an As component is 1 ppb or less, and the average concentration of an Sb component is 70 ppb or less.

A seventh aspect of the invention is a zinc alloy powder for an alkaline manganese dioxide cell in which the average concentration of an iron component in the zinc alloy powder is 5 ppm or less, the average concentration of a Ge component is 27 ppb or less, the average concentration of an As component is 1 ppb or less, and the average concentration of an Sb component is 50 ppb or less.

An eighth aspect of the invention is a zinc alloy powder for an alkaline manganese dioxide cell in which the average concentration of an iron component in the zinc alloy powder is 5 ppm or less, the average concentration of a Ge component is 25 ppb or less, the average concentration of an As component is 5 ppb or less, and the average concentration of an Sb component is 10 ppb or less.

A ninth aspect of the invention is a zinc alloy powder for an alkaline manganese dioxide cell in which the average concentration of an iron component in the zinc alloy powder is 5 ppm or less, the average concentration of a Ge component is 1 ppb or less, the average concentration of an As component is 1 ppb or less, and the average concentration of an Sb component is 110 ppb or less.

A tenth aspect of the invention is a zinc alloy powder for an alkaline manganese dioxide cell in which the average concentration of an iron component in the zinc alloy powder is 5 ppm or less, the average concentration of a Ge component is 29 ppb or less, the average concentration of an As component is 1 ppb or less, and the average concentration of an Sb component is 10 ppb or less.

An eleventh aspect of the invention is a zinc alloy powder for an alkaline manganese dioxide cell in which the average concentration of an iron component in the zinc alloy powder is 5 ppm or less, the average concentration of a Ge component is 4 ppb or less, the average concentration of an As component is 1 ppb or less, and the average concentration of an Sb component is 100 ppb or less.

A twelfth aspect of the invention is a zinc alloy powder for an alkaline manganese dioxide cell in which the average concentration of an iron component in the zinc alloy powder is 5 ppm or less, the average concentration of a Ge component is 10 ppb or less, the average concentration of an As component is 2 ppb or less, and the average concentration of an Sb component is 90 ppb or less.

A thirteenth aspect of the invention is a zinc alloy powder for an alkaline manganese dioxide cell in which the average concentration of an iron component in the zinc alloy powder is 5 ppm or less, the average concentration of a Ge component is 5 ppb or less, the average concentration of an As component is 4 ppb or less, and the average concentration of an Sb component is 90 ppb or less.

A fourteenth aspect of the invention is the zinc alloy powder for the alkaline manganese dioxide cell according to any one of the first to third aspects of the invention in which the average concentration of the Ge component is 20 ppb or less, the average concentration of the As component is 5 ppb or less, and the average concentration of the Sb component is 50 ppb or less.

A fifteenth aspect of the invention is the zinc alloy powder for the alkaline manganese dioxide cell according to any one of the first to third aspects of the invention in which the average concentration of the Ge component is 1 ppb or less, the average concentration of the As component is 5 ppb or less, and the average concentration of the Sb component is 80 ppb or less.

A sixteenth aspect of the invention is the zinc alloy powder for the alkaline manganese dioxide cell according to any one of the first to third aspects of the invention in which the average concentration of the Ge component is 20 ppb or less, the average concentration of the As component is 1 ppb or less, and the average concentration of the Sb component is 70 ppb or less.

A seventeenth aspect of the invention is the zinc alloy powder for the alkaline manganese dioxide cell according to any one of the first to third aspects of the invention in which the average concentration of the Ge component is 27 ppb or less, the average concentration of the As component is 1 ppb or less, and the average concentration of the Sb component is 50 ppb or less.

An eighteenth aspect of the invention is the zinc alloy powder for the alkaline manganese dioxide cell according to any one of the first to third aspects of the invention in which the average concentration of the Ge component is 25 ppb or less, the average concentration of the As component is 5 ppb or less, and the average concentration of the Sb component is 10 ppb or less.

A nineteenth aspect of the invention is the zinc alloy powder for the alkaline manganese dioxide cell according to any one of the first to third aspects of the invention in which the average concentration of the Ge component is 1 ppb or less, the average concentration of the As component is 1 ppb or less, and the average concentration of the Sb component is 110 ppb or less.

A twentieth aspect of the invention is the zinc alloy powder for the alkaline manganese dioxide cell according to any one of the first to third aspects of the invention in which the average concentration of the Ge component is 29 ppb or less, the average concentration of the As component is 1 ppb or less, and the average concentration of the Sb component is 10 ppb or less.

A twenty-first aspect of the invention is the zinc alloy powder for the alkaline manganese dioxide cell according to any one of the first to third aspects of the invention in which the average concentration of the Ge component is 4 ppb or less, the average concentration of the As component is 1 ppb or less, and the average concentration of the Sb component is 100 ppb or less.

A twenty-second aspect of the invention is the zinc alloy powder for the alkaline manganese dioxide cell according to any one of the first to third aspects of the invention in which the average concentration of the Ge component is 10 ppb or less, the average concentration of the As component is 2 ppb or less, and the average concentration of the Sb component is 90 ppb or less.

A twenty-third aspect of the invention is the zinc alloy powder for the alkaline manganese dioxide cell according to any one of the first to third aspects of the invention in which the average concentration of the Ge component is 5 ppb or less, the average concentration of the As component is 4 ppb or less, and the average concentration of the Sb component is 90 ppb or less.

A twenty-fourth aspect of the invention is a zinc alloy powder for an alkaline manganese dioxide cell, which contains 10 to 10,000 ppm each of one or more elements selected from the group consisting of Al, Bi, Ca, In, Pb, Mg and Sn, and in which the proportion of the zinc alloy powder with a mesh size of 48 to 200 is 90% by weight or more, and the proportion of the zinc alloy powder with a mesh size of −200 is 10% by weight or less.

A twenty-fifth aspect of the invention is the zinc alloy powder for the alkaline manganese dioxide cell according to the twenty-fourth aspect of the invention in which the average concentration of an iron component is 5 ppm or less, the average concentration of a Ge component is 20 ppb or less, the average concentration of an As component is 5 ppb or less, and the average concentration of an Sb component is 50 ppb or less.

A twenty-sixth aspect of the invention is the zinc alloy powder for the alkaline manganese dioxide cell according to the twenty-fourth or twenty-fifth aspect of the invention in which the proportion of the zinc alloy powder with a mesh size of 80 to 200 is 70% by weight or more.

A twenty-seventh aspect of the invention is the zinc alloy powder for the alkaline manganese dioxide cell according to any one of the fourth, twenty-fourth and twenty-fifth aspects of the invention in which the proportion of the zinc alloy powder with a mesh size of −150 is 5 to 50% by weight, and the proportion of the zinc alloy powder with a mesh size of +150 is 50 to 95% by weight.

A twenty-eighth aspect of the invention is the zinc alloy powder for the alkaline manganese dioxide cell according to the twenty-seventh aspect of the invention in which the zinc alloy powder with a mesh size of −150 are spherical.

A twenty-ninth aspect of the invention is the zinc alloy powder for the alkaline manganese dioxide cell according to the twenty-seventh-aspect of the invention in which the zinc alloy powder with a mesh size of −150 have been heat-treated in an inert atmosphere.

A thirtieth aspect of the invention is the zinc alloy powder for the alkaline manganese dioxide cell according to any one of the fourth and twenty-fourth to twenty-ninth aspects of the invention, which has been treated with an aqueous solution of potassium hydroxide at a concentration of 10 to 60% by weight.

A thirty-first aspect of the invention is a zinc alloy powder for an alkaline manganese dioxide cell, which contains 10 to 10,000 ppm each of one or more elements selected from the group consisting of Al, Bi, Ca, In, Pb, Mg and Sn, and which has been treated with an aqueous solution of potassium hydroxide at a concentration of 10 to 60% by weight.

A thirty-second aspect of the invention is the zinc alloy powder for the alkaline manganese dioxide cell according to any one of the fourth and twenty-fourth to thirty-first aspects of the invention, which has 0.01 to 10% by weight of a liquid saturated hydrocarbon-based oil mixed therewith.

A thirty-third aspect of the invention is a method for producing a zinc alloy powder for an alkaline manganese dioxide cell, comprising adding one or more elements, selected from the group consisting of Al, Bi, Ca, In, Pb, Mg and Sn, in an amount of 10 to 10,000 ppm each to a zinc metal having an average concentration of an iron component of 5 ppm or less, melting the resulting mixture to form a molten metal, and atomizing the molten metal to produce the zinc alloy powder according to any one of the first to twenty-third aspects of the invention.

A thirty-fourth aspect of the invention is the method for producing the zinc alloy powder for the alkaline manganese dioxide cell according to the thirty-third aspect of the invention, further comprising magnetically separating the zinc alloy powder obtained by atomization.

A thirty-fifth aspect of the invention is a negative electrode for an alkaline manganese dioxide cell, comprising a zinc alloy powder for the alkaline manganese dioxide cell, in which the average concentration of an iron component is 5 ppm or less, the average concentration of a Ge component is 20 ppb or less, the average concentration of an As component is 5 ppb or less, and the average concentration of an Sb component is 50 ppb or less; a liquid saturated hydrocarbon-based oil in an amount of 0.01 to 10% by weight based on the zinc alloy powder for the alkaline manganese dioxide cell; and a gelled electrolyte.

A thirty-sixth aspect of the invention is a negative electrode for an alkaline manganese dioxide cell, comprising the zinc alloy powder for the alkaline manganese dioxide cell according to any one of the fourth and twenty-fourth to thirty-first aspects of the invention, a liquid saturated hydrocarbon-based oil in an amount of 0.01 to 10% by weight based on the zinc alloy powder for the alkaline manganese dioxide cell, and a gelled electrolyte.

A thirty-seventh aspect of the invention is the negative electrode for the alkaline manganese dioxide cell according to the thirty-fifth or thirty-sixth aspect of the invention, wherein the zinc alloy powder for the alkaline manganese dioxide cell has been mixed with the liquid saturated hydrocarbon-based oil.

A thirty-eighth aspect of the invention is the negative electrode for the alkaline manganese dioxide cell according to the thirty-fifth or thirty-sixth aspect of the invention, wherein the gelled electrolyte has been mixed with the liquid saturated hydrocarbon-based oil.

A thirty-ninth aspect of the invention is an alkaline manganese dioxide cell, in which the zinc alloy powder for the alkaline manganese dioxide cell according to any one of the first to thirty-second aspects of the invention is used as a negative electrode active material.

A fortieth aspect of the invention is an alkaline manganese dioxide cell, which has the negative electrode for the alkaline manganese dioxide cell according to any one of the thirty-fifth to thirty-eighth aspects of the invention.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is an explanation drawing of a zinc alloy powder; and

FIG. 2 is a sectional view showing a schematic structure of an alkaline manganese dioxide cell.

### DESCRIPTION OF THE PREFERRED EMBODIMENTS

Preferred embodiments of a zinc alloy powder for an alkaline manganese dioxide cell, and a negative electrode for an alkaline manganese dioxide cell using the zinc alloy powder, and an alkaline manganese dioxide cell using the zinc alloy powder, according to the present invention, will now be described in detail with reference to the accompanying drawings, but these embodiments in no way limit the present invention.

The zinc alloy powder for the alkaline manganese dioxide cell according to the present invention is characterized in that the average concentration of an iron component in the zinc alloy powder is 5 ppm or less, the average concentration of the iron component within a near-surface portion of the zinc alloy powder is 10 ppm or less, and the total content of the iron component in impurities present at the near-surface portion of the zinc alloy powder is 0.5 ppm or less based on the whole body of particles.

If the average concentration of the iron component within the zinc alloy powder exceeds 5 ppm, the average concentration of the iron component within the near-surface portion of the zinc alloy powder has a high absolute value, and gas generation from the alkali manganese dioxide cell is greater than the tolerance. It is particularly preferred that the average concentration of the iron component in the zinc alloy powder exceeds 1 ppm, but is 5 ppm or less. This is because if the average concentration of the iron component in the zinc alloy powder is 1 ppm or less, a zinc metal with very high purity has to be used, and strict management of manufacturing facilities and the manufacturing process is required.

Nor is it preferred that the total content of the iron component in impurities present at the near-surface portion of the zinc alloy powder exceeds 0.5 ppm based on the whole body of particles. In this case, the number of centers of gas generation increases to such an extent that the limits of electrolyte leakage resistance (corrosion resistance) of the cell are broken. A lower value of the total content is preferred, and leads to a decline in gas generation.

If the average concentration of the iron component within the near-surface portion of the zinc alloy powder is more than 10 ppm, the number of centers of gas generation increases to such an extent that the limits of electrolyte leakage resistance (corrosion resistance) of the cell are broken, even when the total content of the iron component in the impurities present at the near-surface portion of the zinc alloy powder is 0.5 ppm or less based on the whole body of particles.

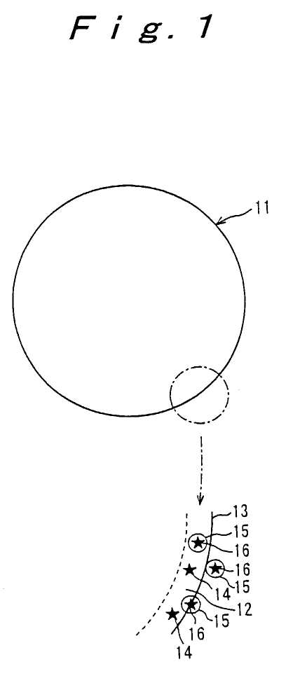

The “near-surface portion” means a region corresponding to a volume of about 1.5% including the surface 13 of a zinc alloy particle 11 and its vicinity, as illustrated in FIG. 1. That is, it is a region corresponding to about 1.5% expressed as a surface layer volume ratio, and it refers to a region indicated by a numeral 12 in FIG. 1.

An iron component 14 within the near-surface portion 12 of the zinc alloy particle 11 refers, for example, to an iron component originally present in the starting zinc metal or in an additive alloy component metal (say, a solid solution). That is, the iron component 14 is that existent in the near-surface portion of the zinc alloy particle among intrinsic iron components present since before the production of the zinc alloy. An iron component 16 in impurities 15 present at the near-surface portion 12 of the zinc alloy particle 11 refers, for example, to an iron component in impurities which are taken up into the zinc alloy particle from outside the system during the production of the zinc alloy and exist within the near-surface portion of the particle or protrude from the surface of the particle (e.g., the impurities are iron oxide such as rust). Alternatively, the iron component 16 refers, for example, to an iron component in impurities which adhere to the surface of the zinc alloy particle from outside the system after the production of the zinc alloy. In other words, the iron component 16 is an extrinsic iron component which becomes existent at the near-surface portion of the zinc alloy particle during or after the production of the zinc alloy powder.

If the average concentration of such an iron component in the zinc alloy is 5 ppm or less, the average concentration of the iron components 14 and 16 within the near-surface portion 12 of the zinc alloy particle 11 is set at 10 ppm or less, and the total content of the iron component 16 in the impurities 15 present at the near-surface portion 12 of the zinc alloy particle 11 is set at 0.5 ppm or less as a proportion to the particle 11, as shown in FIG. 1, abnormal gas generation can be suppressed without the use of a zinc metal with very high purity. Thus, there can be provided a zinc alloy powder for a mercury-free alkaline manganese dioxide cell which can easily realize the suppression of gas generation at a low cost. Eventually, the electrolyte leakage resistance (corrosion resistance) of the mercury-free alkaline manganese dioxide cell can be increased, and its high rate characteristics can be improved.

The iron component-containing impurities, which adhere to the surface of the zinc alloy powder, may be involved in any process present until the manufacturing process for the alkaline manganese dioxide cell after the manufacturing process for the zinc alloy powder. During the manufacturing process for the zinc alloy powder, therefore, a magnetic separator is used to decrease the iron component-containing impurities adhering to the surface of the zinc alloy powder. Even if only the environment of the manufacturing process for the zinc alloy powder is kept very clean, it is difficult to exclude the iron component-containing impurities completely from the negative electrode active material of the alkaline manganese dioxide cell. Thus, it is necessary to strictly manage the environment of the manufacturing process for the alkaline manganese dioxide cell, including a required preliminary step, so that the iron component-containing impurities will not partake.

The main cause of the above-mentioned gas generation is known to be iron, which is present in a tiny amount in the zinc powder, as described in the aforementioned documents 1 to 3 explained in connection with the earlier technologies. The patent document 1, etc. state that when iron-based foreign matter in an amount corresponding to 1 ppm or more based on the whole of the zinc powder is added to the zinc powder from the outside, hydrogen gas occurs from the foreign matter present on the surface of the, zinc powder. However, the documents 1 to 3 are completely silent on the correlations between gas generation and the concentration of the iron component within the near-surface portion of the zinc alloy powder and the total content of the iron component in the impurities present at the near-surface portion of-the zinc alloy powder.

On the other hand, the present inventors thought that what truly affects gas generation is the iron component present in the near-surface portion of the zinc alloy powder. Thus, they speculated that if the concentration of the iron component in the near-surface portion of the zinc alloy powder is kept at an extremely low level, the concentration of the iron component in the entire zinc alloy powder need not be decreased to 1 ppm or less. Accordingly, they wondered if it is not necessary to set the concentration of the iron component of the entire zinc metal, which is used as the starting material, at 1 ppm or less. Based on these speculations, they conducted tests to be described later on, and confirmed that even if the concentration of the iron component in the whole of the zinc alloy powder exceeded 1 ppm, no problem occurred under the above-described conditions. Hence, they accomplished the present invention having the aforementioned features.

It is advised that the zinc alloy powder is the zinc alloy powder containing one or more of Al, Bi, Ca, In, Pb, Mg and-Sn each in an mount of 10 to 10,000 ppm, and the remainder being zinc (Zn). If any of these elements is less than 10 ppm, the effect of its addition, namely, the effect of retaining discharge characteristics (high rate characteristics) for practical use, cannot be shown, even when the generation of hydrogen gas is suppressed. The content in excess of 10,000 ppm is also undesirable, because the effect of addition is not shown any more, and the cost of the zinc alloy powder increases. These elements include components produced as alloy powders during the manufacturing process for the zinc alloy powder, and components integrated with the zinc alloy powder upon addition during the manufacturing process for the alkaline manganese dioxide cell, namely, components precipitated by substitution for zinc and components plated as a result of addition.

The zinc alloy powder for the alkaline manganese dioxide cell according to the present invention is characterized, as one feature, in that the average concentration of an iron component in the zinc alloy powder is 5 ppm or less, the average concentration of a Ge component is 20 ppb or less, the average concentration of an Sb component is 50 ppb or less, and the average concentration of an As component is 5 ppb or less.

In this case, if the average concentration of the Ge component exceeds 20 ppb, the average concentration of the Sb component exceeds 50 ppb, and the average concentration of the As component exceeds 5 ppb at the same time, the undesirable outcome is obtained that gas generation by the alkaline manganese dioxide cell cannot be suppressed.

Preferably, the average concentration of the Ge component is 15 ppb or less, the average concentration of the Sb component is 30 ppb or less, and the average concentration of the As component is 2 ppb or less. More preferably, the average concentration of the Ge component is 10 ppb or less, the average concentration of the Sb component is 20 ppb or less, and the average concentration of the As component is 1 ppb or less.

When the average concentration of the Ge component is 1 ppb or less, if the average concentration of the As component is 5 ppb or less, gas generation by the alkaline manganese dioxide cell can be suppressed by keeping the average concentration of the Sb component down to 80 ppb or less, even if this concentration of the Sb component exceeds 50 ppb. When the average concentration of the As component is 1 ppb or less, if the average concentration of the Ge component is 20 ppb or less, gas generation by the alkaline manganese dioxide cell can be suppressed by keeping the average concentration of the Sb component down to 70 ppb or less, even if this concentration of the Sb component exceeds 50 ppb. When the average concentration of the As component is 1 ppb or less, if the average concentration of the Sb component is 50 ppb or less, gas generation by the alkaline manganese dioxide cell can be suppressed by keeping the average concentration of the Ge component down to 27 ppb or less, even if this concentration of the Ge component exceeds 20 ppb. When the average concentration of the Sb component is 10 ppb or less, if the average concentration of the As component is 5 ppb or less, gas generation by the alkaline manganese dioxide cell can be suppressed by keeping the average concentration of the Ge component down to 25 ppb or less, even if this concentration of the Ge component exceeds 20 ppb.

Furthermore, when the average concentration of the Ge component is 1 ppb or less, and the average concentration of the As component is 1 ppb or less, gas generation by the alkaline manganese dioxide cell can be suppressed, if the average concentration of the Sb component is 110 ppb or less, even if this concentration of the Sb component exceeds 50 ppb. When the average concentration of the As component is 1 ppb or less, and the average concentration of the Sb component is 10 ppb or less, gas generation by the alkaline manganese dioxide cell can be suppressed, if the average concentration of the Ge component is 29 ppb or less, even if this concentration of the Ge component exceeds 20 ppb.

In addition, gas generation by the alkaline manganese dioxide cell can be suppressed, when the average concentration of the Ge component is 4 ppb or less, the average concentration of the As component is 1 ppb or less, and the average concentration of the Sb component is 100 ppb or less at the same time; or when the average concentration of the Ge component is 10 ppb or less, the average concentration of the As component is 2 ppb or less, and the average concentration of the Sb component is 90 ppb or less at the same time; or when the average concentration of the Ge component is 5 ppb or less, the average concentration of the As component is 4 ppb or less, and the average concentration of the Sb component is 90 ppb or less at the same time.

In this case, gas generation by the alkaline manganese dioxide cell can be further kept down to a permissible amount or less, when the average concentration of the iron component in the zinc alloy powder is 5 ppm or less, the average concentration of the Ge component is 20 ppb or less, the average concentration of the Sb component is 50 ppb or less, and the average concentration of the As component is 5 ppb or less, and at the same time, the average concentration of the iron component within the near-surface portion of the zinc alloy powder is 10 ppm or less, and the total content of the iron component in impurities present at the near-surface portion of the zinc alloy powder is 0.5 ppm or less based on the entire particle.

Similar to the aforementioned description, it is preferred that the average concentration of the Ge component is 15 ppb or less, the average concentration of the Sb component is 30 ppb or less, and the average concentration of the As component is 2 ppb or less. It is more preferred that the average concentration of the Ge component is 10 ppb or less, the average concentration of the Sb component is 20 ppb or less, and the average concentration of the As component is 1 ppb or less.

Also similar to the aforesaid description, when the average concentration of the Ge component is 1 ppb or less, if the average concentration of the As component is 5 ppb or less, gas generation by the alkaline manganese dioxide cell can be suppressed by keeping the average concentration of the Sb component at 80 ppb or less, even if this concentration of the Sb component exceeds 50 ppb. When the average concentration of the As component is 1 ppb or less, if the average concentration of the Ge component is 20 ppb or less, gas generation by the alkaline manganese dioxide cell can be suppressed by keeping the average concentration of the Sb component at 70 ppb or less, even if this concentration of the Sb component exceeds 50 ppb. When the average concentration of the As component is 1 ppb or less, if the average concentration of the Sb component is 50 ppb or less, gas generation by the alkaline manganese dioxide cell can be suppressed by keeping the average concentration of the Ge component at 27 ppb or less, even if this concentration of the Ge component exceeds 20 ppb. When the average concentration of the Sb component is 10 ppb or less, if the average concentration of the As component is 5 ppb or less, gas generation by the alkaline manganese dioxide cell can be suppressed by keeping the average concentration of the Ge component at 25 ppb or less, even if this concentration of the Ge component exceeds 20 ppb.

Furthermore, similar to the aforesaid description, when the average concentration of the Ge component is 1 ppb or less, and the average concentration of the As component is 1 ppb or less, gas generation by the alkaline manganese dioxide cell can be suppressed, if the average concentration of the Sb component is 110 ppb or less, even if this concentration of the Sb component exceeds 50 ppb. When the average concentration of the As component is 1 ppb or less, and the average concentration of the Sb component is 10 ppb or less, gas generation by the alkaline manganese dioxide cell can be suppressed, if the average concentration of the Ge component is 29 ppb or less, even if this concentration of the Ge component exceeds 20 ppb.

In addition, similar to the aforesaid description, gas generation by the alkaline manganese dioxide cell can be suppressed, when the average concentration of the Ge component is 4 ppb or less, the average concentration of the As component is 1 ppb or less, and the average concentration of the Sb component is 100 ppb or less at the same time; or when the average concentration of the Ge component is 10 ppb or less, the average concentration of the As component is 2 ppb or less, and the average concentration of the Sb component is 90 ppb or less at the same time; or when the average concentration of the Ge component is 5 ppb or less, the average concentration of the As component is 4 ppb or less, and the average concentration of the Sb component is 90 ppb or less at the same time.

If the above-described ranges are summarized using multiple correlation, they can be expressed in the following equation (1) That is, the relationship expressed by the equation (1) represents the above ranges preferred for suppression of gas generation.

V=−0.0950+0.1382×D_{Ge}+0.4052×D_{As}+0.0348×D_{Sb} (1)

where V represents the gas generation speed (μl/g·d), D_{Ge} is the average concentration (ppb) of the Ge component in the zinc alloy powder, D_{As} is the average concentration (ppb) of the As component in the zinc alloy powder, and D_{Sb} is the average concentration (ppb) of the Sb component in the zinc alloy powder.

The above-mentioned metal components are inevitably carried into the zinc alloy powder. However, the present inventors obtained the finding that gas generation by the alkaline manganese dioxide cell can be suppressed, if these metal components, which are inevitably carried into the zinc alloy powder, satisfy the aforementioned conditions. With this finding, they made the present invention. Because of this invention, even when an ordinary high purity zinc metal is used as a starting material, gas generation by the alkaline manganese dioxide cell can be suppressed, restrictions on the acquisition of the starting material can be markedly eased, and selective use can be made efficiently.

The zinc metal usable as the starting material is an ordinary high purity zinc metal which can be obtained relatively easily by various manufacturing methods, such as distillation, electrolysis, and a combination of distillation and electrolysis. The range of the zinc components of the zinc alloy powder for the mercury-free alkaline manganese dioxide cell can also be broadened compared with the conventional range.

To produce the zinc alloy powder for the mercury-free alkaline manganese dioxide cell according to the present invention, the aforementioned elements are added in predetermined amounts to a zinc metal having an average concentration of an iron component of 5 ppm or less in a chamber in an atmosphere having an average concentration of an iron component of 0.009 mg/m³. The mixture is melted, and the molten metal is atomized by the direct high pressure air method (e.g., ejection pressure 5 kg/cm²) or the like for conversion into a powder. The powder is sifted (e.g., a sieve for a powder size of 20-250 mesh) to select a certain powder size, and if desired, magnetically separated by means of a magnet to remove adherent iron components, whereby the zinc alloy powder can be obtained.

The zinc metal used as the starting material may be one which was obtained by either electrolysis or distillation. The atomization for powder formation is not limited to pneumatic atomization as described above, and maybe, but not limited to, other atomization method, such as an inert gas atomization process or a rotating disk atomization process.

The zinc alloy powder for the alkaline manganese dioxide cell according to the present invention is further characterized by containing 10 to 10,000 ppm each of one or more elements selected from the group consisting of Al, Bi, Ca, In, Pb, Mg and Sn, and is characterized in that the proportion of zinc alloy powder with a mesh size of 48 to 200 is 90% by weight or more, and the proportion of zinc alloy powder with a mesh size of −200 is 10% by weight or less.

If the above elements are not contained or the content of each of the elements exceeds the range defined above, the aforesaid objects of the present invention cannot be achieved. If the powder size distribution of the zinc alloy powder falls within the above range, more preferred results can be obtained.

Also, more preferred results can be obtained for the reasons offered earlier, if, in the zinc alloy powder for the alkaline manganese dioxide cell, the average concentration of the iron component is 5 ppm or less, the average concentration of the Ge component is 20 ppb or less, the average concentration of the As component is 5 ppb or less, and the average concentration of the Sb component is 50 ppb or less.

If, in the zinc alloy powder for the alkaline manganese dioxide cell, the proportion of the zinc alloy powder with a mesh-size of 80 to 200 is 70% by weight or more, the aforementioned objects of the present invention can be attained more remarkably.

In the zinc alloy powder for the alkaline manganese dioxide cell according to the present invention, the proportion of zinc alloy powder with a mesh size of −150 (preferably, a mesh size of 150 to 300) may be 5 to 50% by weight, and the proportion of the zinc alloy powder with a mesh size of +150 (preferably, 20 to 150, more preferably 35 to 150) may be 50 to 95% by weight. This feature is preferred, because the aforementioned objects of the present invention can be attained more remarkably.

The zinc alloy powder with a mesh size of −150 may be spherical. This feature is preferred, because the aforementioned objects of the present invention can be attained more remarkably.

The zinc alloy powder with a mesh size of −150 may have been heat-treated in an inert atmosphere (for example, 300+C×2 hr in an argon atmosphere). This feature is preferred, because the aforementioned objects of the present invention can be attained more remarkably.

The zinc alloy powder for the alkaline manganese dioxide cell according to the present invention may also have been treated with an aqueous solution of potassium hydroxide at a concentration of 10 to 60% by weight. This feature is preferred, because the aforementioned objects of the present invention can be attained more remarkably. If the concentration of the aqueous solution of potassium hydroxide is less than 10% by weight, treatment with potassium hydroxide cannot be sufficiently performed. If the concentration of the aqueous solution of potassium hydroxide exceeds 60% by weight, the zinc alloy powder is dissolved. This treatment with the aqueous solution of potassium hydroxide can be carried out easily by introducing the zinc alloy powder into an aqueous solution of potassium hydroxide having a concentration of 10 to 60% by weight or a mixture of zinc oxide in an aqueous solution of potassium hydroxide having a concentration of 10 to 60% by weight, heating the system, and stirring or allowing it to stand for several days. As a result of this treatment, the active sites of gas generation in the zinc alloy powder are considered to be selectively dissolved with potassium hydroxide, and markedly decreased thereby.

The aforementioned objects of the present invention can also be realized by applying the above-mentioned treatment with the aqueous solution of potassium hydroxide to the zinc alloy powder for the alkaline manganese dioxide cell which contains 10 to 10,000 ppm each of one or more elements selected from the group consisting of Al, Bi, Ca, In, Pb, Mg and Sn.

The zinc alloy powder for the alkaline manganese dioxide cell according to the present invention may have 0.01 to 10% by weight (preferably 0.1 to 10% by weight) of a liquid saturated hydrocarbon-based oil (for example, liquid paraffin) mixed therewith. This feature is preferred, because the aforementioned objects of the present invention can be attained more remarkably. If the amount of the liquid saturated hydrocarbon-based oil mixed with the zinc alloy powder is less than 0.01% by weight, the zinc alloy powder cannot be fully coated with the liquid saturated hydrocarbon-based oil. If the amount of the liquid saturated hydrocarbon-based oil mixed with the zinc alloy powder exceeds 10% by weight, the amount of coating over the zinc alloy powder is so large that a decline in performance is caused when the coated zinc alloy powder is used for the negative electrode of the alkaline manganese dioxide cell. Treatment under the aforementioned conditions is presumed to result in the selective adsorption of the liquid saturated hydrocarbon-based oil onto the active sites of gas generation in the zinc alloy powder, thereby markedly decreasing the activity of gas generation from the zinc alloy powder.

To measure the amount of hydrogen gas generated by the resulting zinc alloy powder, the zinc alloy powder may be immersed in an aqueous solution of potassium hydroxide at 45° C. saturated with zinc oxide in accordance with the customary method. The average concentrations of the alloy components and iron component in the zinc alloy powder can be determined by analysis using the ICP analysis method. The average concentration of the iron component within the near-surface portion of the zinc alloy powder can be determined by dissolving the near-surface portion of the zinc alloy powder with an aqueous solution of diluted nitric acid, and analyzing the zinc content and the amount of the iron component in the aqueous solution. The total content of the iron component in the impurities present at the near-surface portion of the zinc alloy powder can be determined in the following manner: The zinc alloy powder having the near-surface portion dissolved with an aqueous solution of diluted nitric acid are further dissolved entirely with an aqueous solution of diluted nitric acid. Then, the zinc content and the amount of the iron component in the aqueous solution are analyzed, and the difference from the average concentration of the iron component in the near-surface portion is calculated.

The amount of the iron component-containing impurities present at the near-surface portion of the zinc alloy powder can be easily adjusted by such means as the presence or absence of magnetic separation during the manufacturing process, the step of allowing the zinc alloy powder to stand in the open air, the addition of an iron powder to the zinc alloy powder, or the act of dipping the zinc alloy powder in a dilute aqueous solution of iron chloride to substitute iron for zinc and precipitate it.

The above-described zinc alloy powder (3.0 g) for the alkaline manganese dioxide cell, as a negative electrode active material, is mixed with a gelled electrolyte (1.5 g), whereby a negative electrode for the alkaline manganese dioxide cell can be obtained. The above electrolyte comprises an aqueous solution of potassium hydroxide (concentration 40% by weight) saturated with zinc oxide, and carboxymethylcellulose and sodium polyacrylate added (about 1.0%) as gelling agents to the aqueous solution.

If the zinc alloy powder for the alkaline manganese dioxide cell is not the one mixed with the liquid saturated hydrocarbon-based oil, the gelled electrolyte may have been mixed with the liquid saturated hydrocarbon-based oil in an amount of 0.01 to 10% by weight based on the zinc alloy powder for the alkaline manganese dioxide cell. This feature makes it possible to obtain the same effect as that obtained when the zinc alloy powder for the alkaline manganese dioxide cell is mixed with the liquid saturated hydrocarbon-based oil.

This effect can also be obtained when the liquid saturated hydrocarbon-based oil in an amount of 0.01 to 10% by weight based on the zinc alloy powder for the alkaline manganese dioxide cell is added to a mixture of the zinc alloy powder for the alkaline-manganese dioxide cell and the gelled electrolyte.

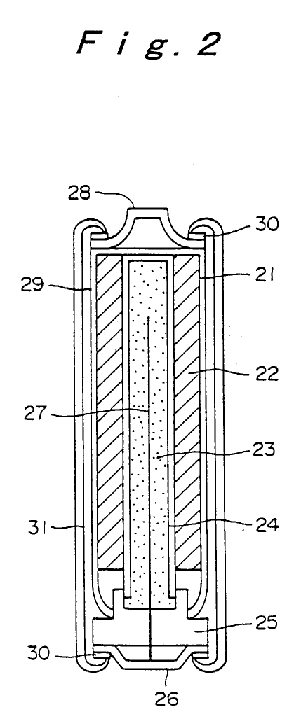

By using the so obtained negative electrode for an alkaline manganese dioxide cell, it becomes possible to prepare an alkaline manganese dioxide cell as shown in FIG. 2. In FIG. 2, the numeral 21 denotes a positive electrode can, 22 a positive electrode, 23 a negative electrode, 24 a separator, 25 a seal, 26 a negative electrode bottom plate, 27 a negative electrode current collector, 28 a cap, 29 a heat-shrinkable resin tube, 30 an insulating ring, and 31 an exterior can.

### EXAMPLES

To confirm the effect of the present invention, the following experiments were conducted based on the foregoing embodiments:

### Example A1

A zinc alloy power was produced by using 100 ppm of Al, 500 ppm of Bi, 200 ppm of Ca, 500 ppm of In and 500 ppm of Pb as alloy components, and setting the average concentration of an iron component in the zinc alloy powder (namely, concentration 1) at 5 ppm, setting the proportion, to zinc alloy powder, of the total content of the iron component in impurities present at a near-surface portion of the zinc alloy powder (i.e., concentration 2) at 0.5 ppm, and setting the average concentration of the iron component within the near-surface portion of the zinc alloy powder (i.e., concentration 3) at 8 ppm.

As the incidental impurities, the average concentration of a Ge component was set at 20 ppb or less, the average concentration of an Sb component was set at 50 ppb or less, and the average concentration of an As component was set at 5 ppb or less.

### Example A2

A zinc alloy powder was produced by setting the Concentration 3 at 10 ppm, and setting the other conditions to be the same as in Example A1.

### Example A3

A zinc alloy powder was produced by setting the Concentration 2 at 0.3 ppm, and setting the other conditions to be the same as in Example A2.

### Example A4

A zinc alloy powder was produced by setting the Concentration 1 at 3 ppm, and setting the other conditions to be the same as in Example A2.

### Example A5

A zinc alloy powder was produced by setting the Concentration 1 at 2 ppm, and setting the other conditions to be the same as in Example A1.

### Example A6

A zinc alloy powder was produced by setting the Concentration 1 at 1.5 ppm, and setting the other conditions to be the same as in Example A1.

### Example A7

A zinc alloy powder was produced in the same manner as in Example A1, except that 100 ppm of Mg was added as an alloy component.

### Example A8

A zinc alloy powder was produced in the same manner as in Example A1, except that 100 ppm of Sn was added as an alloy component.

### Example A9

A zinc alloy powder was produced in the same manner as in Example A1, except that 100 ppm of Mg and 100 ppm of Sn were added as alloy components.

### Comparative Example A1

A zinc alloy powder was produced by setting the Concentration 3 at 15 ppm, and setting the other conditions to be the same as in Example A1.

### Comparative Example A2

A zinc alloy powder was produced by setting the Concentration 2 at 0.7 ppm, and setting the other conditions to be the same as in Comparative Example A1.

### Comparative Example A3

A zinc alloy powder was produced by setting the Concentration 1 at 6 ppm, and setting the other conditions to be the same as in Comparative Example A1.

### Comparative Example A4

A zinc alloy powder was produced in the same manner as in Comparative Example A1, except that 100 ppm of Mg was added as an alloy component.

### Comparative Example A5

A zinc alloy powder was produced in the same manner as in Comparative Example A1, except that 100 ppm of Sn was added as an alloy component.

### Comparative Example A6

A zinc alloy powder was produced in the same manner as in Comparative Example A1, except that 100 ppm of Mg and 100 ppm of Sn were added as alloy components.

The production of the zinc alloy powder was performed in the following manner: A zinc metal, in which the average concentration of an iron component satisfied the aforementioned conditions, was melted in a chamber in an atmosphere having an average concentration of an iron component of 0.009 mg/m³. The resulting molten metal having the aforementioned elements added in the aforementioned amounts was atomized by the direct high pressure air method (e.g., ejection pressure 5 kg/cm²) for conversion into a powder. The powder was sifted (e.g., a sieve for a powder size of 20-250 mesh), and where necessary, magnetically separated using a magnet, to remove a free iron powder adhering to the surface. The zinc metal, used as the starting material, was obtained by electrolysis.

The amount of hydrogen gas generated by the resulting zinc alloy powder (i.e., the amount of a source powder gas) was measured in the customary manner by immersing 10 g of the zinc alloy powder in 5 ml of an aqueous solution of potassium hydroxide (concentration 40% by weight) saturated with zinc oxide, and allowing this system to stand for 3 days at 45° C. The average concentrations of the alloy components and iron component in the zinc alloy powder were determined by analysis using the ICP analysis method. The average concentration of the iron component within the near-surface portion of the zinc alloy powder was determined by dissolving the near-surface portion of the zinc alloy powder with an aqueous solution of diluted nitric acid, and analyzing the zinc content and the amount of the iron component in the aqueous solution. The total content of the iron component in the impurities present at the near-surface portion of the zinc alloy powder was determined in the following manner: The zinc alloy powder having the near-surface portion dissolved with an aqueous solution of diluted nitric acid were further dissolved entirely with an aqueous solution of diluted nitric acid. Then, the zinc content and the amount of the iron component in the aqueous solution were analyzed, and the difference from the average concentration of the iron component in the near-surface portion was calculated. In increasing the concentration of the iron component present in the near-surface portion of the zinc alloy powder, an iron powder was added to the alloy powder.

The results of Examples A1 to A9 and Comparative Examples A1 to A6 performed under the above-described conditions are shown in Table 1.

TABLE 1

| | | | | | | | | | | | Amount of source |
|---|---|---|---|---|---|---|---|---|---|---|---|
| | Composition of alloy (ppm) | | | | | | | Fe Con. 1 | Fe Con. 2 | Fe Con. 3 | powder gas |
| | Al | Bi | Ca | In | Pb | Mg | Sn | (ppm) | (ppm) | (ppm) | (μl/g · d) |
| Ex. A1 | 100 | 500 | 200 | 500 | 500 | 0 | 0 | 5 | 0.5 | 8 | 3 |
| Ex. A2 | 100 | 500 | 200 | 500 | 500 | 0 | 0 | 5 | 0.5 | 10 | 5 |
| Ex. A3 | 100 | 500 | 200 | 500 | 500 | 0 | 0 | 5 | 0.3 | 10 | 3 |
| Ex. A4 | 100 | 500 | 200 | 500 | 500 | 0 | 0 | 3 | 0.5 | 10 | 4 |
| Ex. A5 | 100 | 500 | 200 | 500 | 500 | 0 | 0 | 2 | 0.5 | 8 | 2 |
| Ex. A6 | 100 | 500 | 200 | 500 | 500 | 0 | 0 | 1.5 | 0.5 | 8 | 2 |
| Ex. A7 | 100 | 500 | 200 | 500 | 500 | 100 | 0 | 5 | 0.5 | 10 | 4 |
| Ex. A8 | 100 | 500 | 200 | 500 | 500 | 0 | 100 | 5 | 0.5 | 10 | 4 |
| Ex. A9 | 100 | 500 | 200 | 500 | 500 | 100 | 100 | 5 | 0.5 | 10 | 5 |
| C. Ex. A1 | 100 | 500 | 200 | 500 | 500 | 0 | 0 | 5 | 0.5 | 15 | 12 |
| C. Ex. A2 | 100 | 500 | 200 | 500 | 500 | 0 | 0 | 5 | 0.7 | 15 | 17 |
| C. Ex. A3 | 100 | 500 | 200 | 500 | 500 | 0 | 0 | 6 | 0.5 | 15 | 16 |
| C. Ex. A4 | 100 | 500 | 200 | 500 | 500 | 100 | 0 | 5 | 0.5 | 15 | 11 |
| C. Ex. A5 | 100 | 500 | 200 | 500 | 500 | 0 | 100 | 5 | 0.5 | 15 | 11 |
| C. Ex. A6 | 100 | 500 | 200 | 500 | 500 | 100 | 100 | 5 | 0.5 | 15 | 10 |

Ex. = Example
C. Ex. = Comparative Example
Con. = Concentration

As Table 1 shows, gas generation was suppressed in Examples A1 to A9, but gas generation was not suppressed in Comparative Examples A1 to A6. These results show that when the concentration of the iron component present in the near-surface portion of the zinc alloy powder is high, the gas generation speed is high.

### Example B1

A zinc alloy power was produced by using 100 ppm of Al, 500 ppm of Bi, 200 ppm of Ca, 500 ppm of In, 500 ppm of Pb, 50 ppm of Mg and 50 ppm of Sn as alloy components; setting the average concentration of a Ge component at 20 ppb, the average concentration of an Sb component at 50 ppb, and the average concentration of an As component at 5 ppb; and setting the average concentration of an iron component in the zinc alloy powder (namely, concentration 1) at 5 ppm or less, setting the proportion, to zinc alloy powder, of the total content of the iron component in impurities present at the near-surface portion of the zinc alloy powder (i.e., concentration 2) at 0.5 ppm or less, and setting the average concentration of the iron component within the near-surface portion of the zinc alloy powder (i.e., concentration 3) at 10 ppm or less.

### Example B2

A zinc alloy powder was produced by setting the average concentration of the Ge component at 15 ppb, the average concentration of the Sb component at 30 ppb, and the average concentration of the As component at 2 ppb, and setting the other conditions to be the same as in Example B1.

### Example B3

A zinc alloy powder was produced by setting the average concentration of the Ge component at 10 ppb, the average concentration of the Sb component at 20 ppb, and the average concentration of the As component at 1 ppb, and setting the other conditions to be the same as in Example B1.

### Example B4

A zinc alloy powder was produced by setting the average concentration of the Ge component at 3 ppb, the average concentration of the Sb component at 10 ppb, and the average concentration of the As component at 1 ppb, and setting the other conditions to be the same as in Example B1.

### Comparative Example B1

A zinc alloy powder was produced by setting the average concentration of the Ge component at 30 ppb, the average concentration of the Sb component at 70 ppb, and the average concentration of the As component at 10 ppb, and setting the other conditions to be the same as in Example B1.

The results of Examples B1 to B4 and Comparative Example B1 performed under the above-described conditions are shown in Table 2.

TABLE 2

| | | | | | | | | | | | Amount of source |
|---|---|---|---|---|---|---|---|---|---|---|---|
| | Composition of alloy (ppm) | | | | | | | Ge | As | Sb | powder gas |
| | Al | Bi | Ca | In | Pb | Mg | Sn | (ppb) | (ppb) | (ppb) | (μl/g · d) |
| Ex. B1 | 100 | 500 | 200 | 500 | 500 | 50 | 50 | 20 | 5 | 50 | 5 |
| Ex. B2 | 100 | 500 | 200 | 500 | 500 | 50 | 50 | 15 | 2 | 30 | 3 |
| Ex. B3 | 100 | 500 | 200 | 500 | 500 | 50 | 50 | 10 | 1 | 20 | 1 |
| Ex. B4 | 100 | 500 | 200 | 500 | 500 | 50 | 50 | 3 | 1 | 10 | 0.5 |
| C. Ex. B1 | 100 | 500 | 200 | 500 | 500 | 50 | 50 | 30 | 10 | 70 | 21 |

Ex. = Example
C. Ex. = Comparative Example

As Table 2 shows, gas generation was suppressed in Examples B1 to B4, but gas generation was not suppressed in Comparative Example B1.

### Examples C1 to C42

As Table 3 below shows, the respective elements were added in predetermined amounts to obtain zinc alloy powders of Examples C1 to C42. The results are shown in Table 3.

TABLE 3

| | | | | | | | | | | Amount of source |
|---|---|---|---|---|---|---|---|---|---|---|
| | Composition of alloy (ppm) | | | | | | | Fe Con. 1 | Fe Con. 2 | powder gas |
| | Al | Bi | Ca | In | Pb | Mg | Sn | (ppm) | (ppm) | (μl/g · d) |
| Ex. C1 | 100 | 500 | 200 | 500 | 500 | 100 | 0 | 5 | 0.5 | 3 |
| Ex. C2 | 100 | 500 | 200 | 500 | 500 | 0 | 100 | 5 | 0.1 | 1 |
| Ex. C3 | 100 | 500 | 200 | 500 | 500 | 50 | 50 | 1 | 0.5 | 4 |
| Ex. C4 | 100 | 500 | 200 | 500 | 12 | 0 | 0 | 4 | 0.4 | 2 |
| Ex. C5 | 100 | 500 | 200 | 11 | 500 | 0 | 0 | 3 | 0.2 | 2 |
| Ex. C6 | 100 | 500 | 10 | 500 | 500 | 0 | 0 | 5 | 0.4 | 3 |
| Ex. C7 | 100 | 12 | 200 | 500 | 500 | 0 | 0 | 2 | 0.2 | 1 |
| Ex. C8 | 10 | 500 | 200 | 500 | 500 | 0 | 0 | 5 | 0.3 | 2 |
| Ex. C9 | 100 | 500 | 200 | 500 | 0 | 0 | 0 | 4 | 0.5 | 4 |
| Ex. C10 | 100 | 500 | 200 | 0 | 500 | 0 | 0 | 5 | 0.4 | 4 |
| Ex. C11 | 100 | 500 | 0 | 500 | 500 | 0 | 0 | 4 | 0.5 | 4 |
| Ex. C12 | 100 | 0 | 200 | 500 | 500 | 0 | 0 | 3 | 0.3 | 2 |
| Ex. C13 | 0 | 500 | 200 | 500 | 500 | 0 | 0 | 5 | 0.4 | 4 |
| Ex. C14 | 100 | 500 | 200 | 10 | 0 | 0 | 0 | 4 | 0.3 | 2 |
| Ex. C15 | 100 | 500 | 11 | 500 | 0 | 0 | 0 | 4 | 0.4 | 4 |
| Ex. C16 | 10 | 12 | 200 | 500 | 0 | 0 | 0 | 5 | 0.3 | 3 |
| Ex. C17 | 11 | 500 | 200 | 500 | 0 | 0 | 0 | 4 | 0.5 | 4 |
| Ex. C18 | 100 | 500 | 0 | 500 | 12 | 0 | 0 | 5 | 0.4 | 3 |
| Ex. C19 | 100 | 500 | 200 | 0 | 0 | 0 | 0 | 4 | 0.5 | 4 |
| Ex. C20 | 100 | 500 | 0 | 500 | 0 | 0 | 0 | 1 | 0.5 | 4 |
| Ex. C21 | 100 | 500 | 0 | 500 | 0 | 0 | 0 | 4 | 0.5 | 1 |
| Ex. C22 | 100 | 500 | 0 | 500 | 0 | 0 | 0 | 5 | 0.5 | 4 |
| Ex. C23 | 100 | 0 | 200 | 500 | 0 | 0 | 0 | 4 | 0.3 | 3 |
| Ex. C24 | 0 | 500 | 200 | 500 | 0 | 0 | 0 | 4 | 0.4 | 4 |
| Ex. C25 | 100 | 500 | 11 | 0 | 0 | 0 | 0 | 5 | 0.5 | 4 |
| Ex. C26 | 100 | 500 | 0 | 12 0 | 0 | 0 | 4 | 0.4 | 3 | |
| Ex. C27 | 100 | 0 | 200 | 11 | 0 | 0 | 0 | 3 | 0.3 | 2 |
| Ex. C28 | 10 | 12 | 200 | 0 | 0 | 0 | 0 | 5 | 0.2 | 2 |
| Ex. C29 | 100 | 13 | 0 | 500 | 0 | 0 | 0 | 4 | 0.4 | 4 |
| Ex. C30 | 100 | 0 | 11 | 500 | 0 | 0 | 0 | 3 | 0.5 | 4 |
| Ex. C31 | 0 | 500 | 200 | 13 | 0 | 0 | 0 | 3 | 0.4 | 4 |
| Ex. C32 | 0 | 500 | 11 | 500 | 0 | 100 | 100 | 3 | 0.4 | 4 |
| Ex. C33 | 0 | 500 | 0 | 500 | 11 | 100 | 0 | 5 | 0.5 | 4 |
| Ex. C34 | 100 | 10 | 0 | 0 | 0 | 0 | 0 | 4 | 0.4 | 4 |
| Ex. C35 | 100 | 0 | 12 | 0 | 0 | 0 | 0 | 3 | 0.4 | 3 |
| Ex. C36 | 100 | 0 | 0 | 11 | 0 | 0 | 0 | 4 | 0.3 | 3 |
| Ex. C37 | 100 | 0 | 0 | 0 | 13 | 0 | 0 | 3 | 0.4 | 4 |
| Ex. C38 | 0 | 500 | 1 | 0 | 0 | 0 | 0 | 3 | 0.5 | 4 |
| Ex. C39 | 0 | 500 | 0 | 12 | 0 | 0 | 0 | 3 | 0.4 | 3 |
| Ex. C40 | 0 | 500 | 0 | 0 | 12 | 0 | 0 | 4 | 0.3 | 3 |
| Ex. C41 | 0 | 0 | 200 | 12 | 0 | 0 | 0 | 3 | 0.3 | 4 |
| Ex. C42 | 0 | 0 | 300 | 0 | 11 | 0 | 0 | 3 | 0.4 | 4 |

Ex. = Example
Con = Concentration

As will be clear from Table 3, the zinc alloy powders of Examples C1 to C42 were all able to suppress the generation of hydrogen gas, and can be applied as zinc alloy powders for mercury-free alkaline manganese dioxide cells improved in the electrolyte leakage resistance of the cell.

### Examples D1 to D14 and Comparative Examples D1 to D6

As Table 4 below shows, the respective elements were added in predetermined amounts to obtain zinc alloy powders of Examples D1 to D14 and Comparative Examples D1 to D6. The average concentration of the iron component in each of these zinc alloys was 5 ppm or less. The results are shown in Table 4.

TABLE 4

| | | | | Amount of source |
|---|---|---|---|---|
| | Ge | As | Sb | powder gas |
| | (ppb) | (ppb) | (ppb) | (μl/g· d) |
| Ex.D1 | 1 | 5 | 80 | 4 |
| Ex.D2 | 20 | 1 | 70 | 5 |
| Ex.D3 | 27 | 1 | 50 | 4 |
| Ex.D4 | 25 | 5 | 10 | 5 |
| Ex.D5 | 1 | 1 | 110 | 4 |
| Ex.D6 | 29 | 1 | 10 | 4 |
| Ex.D7 | 3 | 1 | 10 | 2 |
| Ex.D8 | 1 | 5 | 20 | 3 |
| Ex.D9 | 2 | 1 | 30 | 1 |
| Ex.D10 | 1 | 1 | 90 | 3 |
| Ex.D11 | 1 | 1 | 5 | 0.5 |
| Ex.D12 | 4 | 1 | 100 | 5 |
| Ex.D13 | 10 | 2 | 90 | |
| Ex.D14 | 5 | 4 | 90 | |
| C.Ex.D1 | 1 | 5 | 90 | 6 |
| C.Ex.D2 | 20 | 1 | 80 | 6 |
| C.Ex.D3 | 35 | 1 | 50 | 7 |
| C.Ex.D4 | 35 | 5 | .10 | 8 |
| C.Ex.D5 | 1 | 1 | 120 | 6 |
| C.Ex.D6 | 35 | 1 | 10 | 7 |

Ex. = Example
C.Ex. = Comparative Example

As will be clear from Table 4, the zinc alloy powders of Comparative Examples D1 to D6 were unable to suppress gas generation, and cannot be applied as zinc alloy powders for mercury-free alkaline manganese dioxide cells, while the zinc alloy powders of Examples D1 to D14 according to the present invention were all able to suppress the generation of hydrogen gas, and can be applied as zinc alloy powders for mercury-free alkaline manganese dioxide cells improved in the electrolyte leakage resistance (corrosion resistance) of the cell.

### Example E1 and Comparative Example E1

As Table 5 below shows, the respective elements were added in predetermined amounts to obtain zinc alloy powders of Example E1 (with magnetic separation) and Comparative Example E1 (without magnetic separation) The average concentration of the iron component in each of these zinc alloys was 5 ppm or less. The results are shown in Table 5.

TABLE 5

| | | | | | | | | | | | Amount of source |
|---|---|---|---|---|---|---|---|---|---|---|---|
| | Composition of alloy (ppm) | | | | | | | Presence or absence of | Fe Con. 1 | Fe Con. 3 | powder gas |
| | Al | Bi | Ca | In | Pb | Mg | Sn | magnetic separation | (ppm) | (ppm) | (μl/g · d) |
| Ex. E1 | 100 | 500 | 200 | 500 | 500 | 100 | 100 | Present | 5 | 6 | 3 |
| C. Ex. E1 | 100 | 500 | 200 | 500 | 500 | 0 | 0 | Absent | 5 | 10 | 6 |

Ex. = Example
C. Ex. = Comparative Example
Con. = Concentration

As will be clear from Table 5, the zinc alloy powder of Comparative Example E1 was unable to suppress gas generation, and cannot be applied as the zinc alloy powder for a mercury-free alkaline manganese dioxide cell, while the zinc alloy powder of Example E1 according to the present invention was able to suppress the generation of hydrogen gas, and can be applied as the zinc alloy powder for a mercury-free alkaline manganese dioxide cell improved in the electrolyte leakage resistance (corrosion resistance) of the cell.

<Cell Gas Characteristics>

The zinc alloy powders in the above Examples A1 to A3, B1 and B2, C1 to C3, D1 to D3 and E1 and Comparative Examples A1 to A3, B1, D1 to D3 and E1 were used in negative electrodes to prepare alkaline manganese dioxide cells (Japanese Industrial Standards “LR6” model), and these cells were measured for the amount of a post-discharge gas (cell gas characteristics). Concretely, the following procedure was performed: Each of the resulting alkaline manganese dioxide cells was held in an environment at 20° C. for 7 days. Then, the cell was continuously discharged at a constant discharge resistance (1Ω) down to a prescribed final (cut) voltage (0.2V), and held under the condition of at 60° C. for 3 days. Then, the cell was unsealed in a water bath equipped with a gas catcher, and the amount of gas generated in the cell was measured. The results are shown in Table 6.

TABLE 6

Amount of post-discharge gas
(μl/cell · d)

| | |
|---|---|
| Example A1 | 300 |
| Example A2 | 360 |
| Example A3 | 300 |
| Example D1 | 360 |
| Example B2 | 300 |
| Example C1 | 300 |
| Example C2 | 150 |
| Example C3 | 330 |
| Example D1 | 330 |
| Example D2 | 360 |
| Example D3 | 330 |
| Example E1 | 300 |
| Comparative Example A1 | 900 |
| Comparative Example A2 | 1500 |
| Comparative Example A3 | 1200 |
| Comparative Example D1 | 1800 |
| Comparative Example D1 | 540 |
| Comparative Example D2 | 540 |
| Comparative Example D3 | 600 |
| Comparative Example E1 | 430 |

Table 6 shows that in comparison with the alkaline manganese dioxide cells prepared using the zinc alloy powders of Comparative Examples A1 to A3, B1, D1 to D3 and E1 for the negative electrodes, the alkaline manganese dioxide cells prepared using the zinc alloy powders of Examples A1 to A3, B1 to B2, C1 to C3, D1 to D3 and E1 for the negative electrodes were able to suppress gas generation, and can be applied as zinc alloy powders for mercury-free alkaline manganese dioxide cells improved in the electrolyte leakage resistance (corrosion resistance) of the cell.

### Example F1

A zinc alloy powder containing 230 ppm of Bi, 230 ppm of In and 142 ppm of Ca and comprising 92% by weight of the powder with a mesh size of 48 to 200 and 8% by weight of the powder with a mesh size of −200 was obtained by atomizing an alloy melt prepared so as to have a predetermined alloy composition.

### Example F2

A zinc alloy powder of Example F2 was obtained by coating the zinc alloy powder, which had been obtained in Example F1, with liquid paraffin in an amount of 2% by weight.

### Example F3

A zinc alloy powder of Example F3 was obtained by dipping the zinc alloy powder, which had been obtained in Example F1, in an aqueous solution of potassium hydroxide at a concentration of 40% by weight, and allowing it to stand for 3 days with heating.

### Example F4

The zinc alloy powder obtained in Example F1 was sifted, and the powder comprising fine powder with a mesh size of −150 was heat-treated (300° C·2 hr) in an argon atmosphere. Then, this powder comprising the fine powder and the powder comprising coarse powder with a mesh size of +150 were mixed at a weight ratio of 42:58 to obtain a zinc alloy powder of Example F4.

### Example F5

A zinc alloy powder of Example F5 was obtained by coating the zinc alloy powder, which had been obtained in Example F4, with liquid paraffin in an amount of 2% by weight.

### Example F6

A zinc alloy powder of Example F6 was obtained by dipping the zinc alloy powder, which had been obtained in Example F4, in an aqueous solution of potassium hydroxide at a concentration of 40% by weight, and allowing it to stand for 3 days with heating.

### Example F7

The zinc alloy powder obtained in Example F1 was sifted to remove the powder comprising fine powder with a mesh size of −150. The remaining powder comprising coarse powder with a mesh size of +150 and the powder comprising fine spherical powder with a mesh size of −150 were mixed at a weight ratio of 58:42 to obtain a zinc alloy powder of Example F7.

### Example F8

A zinc alloy powder of Example F8 was obtained by coating the zinc alloy powder, which had been obtained in Example F7, with liquid paraffin in an amount of 2% by weight.

### Example F9

A zinc alloy powder of Example F9 was obtained by dipping the zinc alloy powder, which had been obtained in Example F7, in an aqueous solution of potassium hydroxide at a concentration of 40% by weight, and allowing it to stand for 3 days with heating.

### Comparative Example F1

A zinc alloy powder containing 230 ppm of Bi, 230 ppm of In and 142 ppm of Ca and comprising 72% by weight of the powder with a mesh size of 48 to 200 and 28% by weight of the powder with a mesh size of −200 was obtained by atomizing an alloy melt prepared so as to have a predetermined alloy composition.

The characteristics of the thus obtained zinc alloy powders of Examples F1 to F9 and Comparative Example F1, and alkaline manganese dioxide cells using these zinc alloy powers as negative electrode active materials were evaluated. The results are shown in Table 7 below. The discharge duration index was determined as a relative index in the experiments for measurement of the amount of post-discharge gas, with the discharge duration of Comparative Example F1 until a drop to a prescribed voltage of 0.9 V before the final (cut) voltage of 0.2 V being taken as 100.

TABLE 7

| | | | | | |
|---|---|---|---|---|---|
| | | | Amount of | Discharge | Amount of |
| Particle | Particle size | Conditions for treatment | source | duration | post-discharge |

| | | | | | | |
|---|---|---|---|---|---|---|
| size | proportion (%) | Heat- | Spherical | powder gas | index | gas |

| | mesh | 48-200 | −200 | Coating | treatment | powder | KOH | *μl/g · d) | (%) | (ml) |
|---|---|---|---|---|---|---|---|---|---|---|
| Ex. F1 | 48-200 | 92 | 8 | — | — | — | — | 7.4 | 107 | 1.86 |
| Ex. F2 | 48-200 | 92 | 8 | ∘ | — | — | — | 8.3 | 110 | 1.30 |
| Ex. F3 | 48-200 | 92 | 8 | — | — | — | ∘ | 3.7 | 101 | 1.48 |
| Ex. F4 | 48-200 | 92 | 8 | — | ∘ | — | — | 6.9 | 102 | 1.47 |
| Ex. F5 | 48-200 | 92 | 8 | ∘ | ∘ | — | — | 6.6 | 112 | 1.03 |
| Ex. F6 | 48-200 | 92 | 8 | — | ∘ | — | ∘ | 2.8 | 102 | 1.17 |
| Ex. F7 | 48-200 | 92 | 8 | — | — | ∘ | — | 6.9 | 105 | 1.78 |
| Ex. F8 | 48-200 | 92 | 8 | — | ∘ | ∘ | — | 5.2 | 103 | 1.41 |
| Ex. F9 | 48-200 | 92 | 8 | — | — | ∘ | ∘ | 2.8 | 100 | 1.43 |
| C. Ex. F1 | 48-200 | 73 | 27 | — | — | — | — | 9.2 | 100 | 2.32 |

Ex. = Example
C. Ex. = Comparative Example

Table 7 shows that in comparison with the alkaline manganese dioxide cell prepared using the zinc alloy powder of Comparative Example F1 as the negative electrode active material, the alkaline manganese dioxide cells prepared using the zinc alloy powders of Examples F1 to F9 as the negative electrode active materials were able to suppress gas generation, and can improve the electrolyte leakage resistance (corrosion resistance) and the high rate characteristics of the cell.

### Example G1

An alloy melt prepared so as to have a predetermined alloy composition was atomized to obtain a zinc alloy powder containing 5 ppm or less of Fe, 20 ppb or less of Ge, 5 ppb or less of As, 50 ppb or less of Sb, 100 ppm of Al, 500 ppm of Bi, 200 ppm of Ca, 500 ppm of In and 500 ppm of Pb and comprising 92% by weight of powder with a mesh size of 48 to 200 and 8% by weight of powder with a mesh size of −200.

### Example G2

The zinc alloy powder obtained in Example G1 was subjected to the same procedure as in the aforementioned Example F2 to obtain a zinc alloy powder of Example G2.

### Example G3

The zinc alloy powder obtained in Example G1 was subjected to the same procedure as in the aforementioned Example F3 to obtain a zinc alloy powder of Example G3.

### Example G4

The zinc alloy powder obtained in Example G1 was subjected to the same procedure as in the aforementioned Example F4 to obtain a zinc alloy powder of Example G4.

### Example G5

The zinc alloy powder obtained in Example G4 was subjected to the same procedure as in the aforementioned Example F5 to obtain a zinc alloy powder of Example G5.

### Example G6

The zinc alloy powder obtained in Example G4 was subjected to the same procedure as in the aforementioned Example F6 to obtain a zinc alloy powder of Example G6.

### Example G7

The zinc alloy powder obtained in Example G1 was subjected to the same procedure as in the aforementioned Example F7 to obtain a zinc alloy powder of Example G7.

### Example G8

The zinc alloy powder obtained in Example G7 was subjected to the same procedure as in the aforementioned Example F8 to obtain a zinc alloy powder of Example G8.

### Example G9

The zinc alloy powder obtained in Example G7 was subjected to the same procedure as in the aforementioned Example F9 to obtain a zinc alloy powder of Example G9.

### Comparative Example G1

The same zinc alloy powder as in Comparative Example F1 was used.

### Comparative Example G2

An alloy melt prepared so as to have a predetermined alloy composition was atomized to obtain a zinc alloy powder containing 5 ppm of Fe, 30 ppb of Ge, 10 ppb or less of As, 70 ppb or less of Sb, 230 ppm of Bi, 142 ppm of Ca, and 230 ppm of In and comprising 65% by weight of powder with a mesh size of 80 to 200 and 35% by weight of powder with a mesh size of −200.

The characteristics of the thus obtained zinc alloy powders of Examples G1 to G9 and Comparative Examples G1 and G2, and alkaline manganese dioxide cells using these zinc alloy powers as negative electrode active materials were evaluated. The results are shown in Table 8 below.

TABLE 8

| | | | | | | | | Amount of | Discharge | Amount of |
|---|---|---|---|---|---|---|---|---|---|---|
| | Particle | Particle size | | Conditions for treatment | | | | source | duration | post-discharge |
| | size | proportion (%) | | | Heat- | Spherical | | powder gas | index | gas |
| | mesh | 48-200 | −200 | Coating | treatment | powder | KOH | (μl/g · d) | (%) | (ml) |
| Ex. G1 | 48-200 | 92 | 8 | — | — | — | — | 6.0 | 106 | 1.51 |
| Ex. G2 | 48-200 | 92 | 8 | ∘ | — | ‘3 | — | 5.4 | 110 | 1.32 |
| Ex. G3 | 48-200 | 92 | 8 | — | — | — | ∘ | 2.4 | 101 | 1.51 |
| Ex. G4 | 48-200 | 92 | 8 | — | ∘ | — | — | 4.5 | 102 | 1.49 |
| Ex. G5 | 48-200 | 92 | 8 | ∘ | ∘ | — | — | 2.0 | 111 | 1.05 |
| Ex. G6 | 48-200 | 92 | 8 | — | ∘ | ‘3 | ∘ | 1.8 | 102 | 1.19 |
| Ex. G7 | 48-200 | 92 | 8 | — | — | ∘ | — | 4.5 | 104 | 1.81 |
| Ex. G8 | 48-200 | 92 | 8 | — | ∘ | ∘ | — | 4.0 | 103 | 1.27 |
| Ex. G9 | 48-200 | 92 | 8 | — | — | ∘ | ∘ | 1.8 | 100 | 1.45 |
| C. Ex. G1 | 48-200 | 73 | 27 | — | — | — | — | 8.3 | 100 | 1.89 |
| C. Ex. G2 | 80-200 | 72 | 28 | — | — | — | — | 9.5 | 105 | 1.94 |

Ex. = Example
C. Ex. = Comparative Example

Table 8 shows that in comparison with the alkaline manganese dioxide cells prepared using the zinc alloy powders of Comparative Examples G1 and G2 as the negative electrode active materials, the alkaline manganese dioxide cells prepared using the zinc alloy powders of Examples G1 to G9 as the negative electrode active materials were able to suppress gas generation, and can improve the electrolyte leakage resistance (corrosion resistance) and the high rate characteristics of the cell.

### Example H1

An alloy melt prepared so as to have a predetermined alloy composition was atomized to obtain a zinc alloy powder H containing 5 ppm or less of Fe, 20 ppb or less of Ge, 5 ppb,or less of As, 50 ppb or less of Sb, 100 ppm of Al, 500 ppm of Bi, 200 ppm of Ca, 500 ppm of In and 500 ppm of Pb.

Then, the above zinc alloy powder H was subjected to the same procedure as in the aforementioned Examples F2 and G2 to obtain a zinc alloy powder of Example H1.

### Example H2

The zinc alloy powder H produced in Example H1 was subjected to the same procedure as in the aforementioned Examples F3 and G3 to obtain a zinc alloy powder of Example H2.

### Example H3

The zinc alloy powder H produced in Example H1 was subjected to the same procedure as in the aforementioned Examples F4 and G4 to obtain a zinc alloy powder of Example H3.

### Example H4

The zinc alloy powder H produced in Example H1 was subjected to the same procedure as in the aforementioned Examples F5 and G5 to obtain a zinc alloy powder of Example H4.

### Example H5

The zinc alloy powder H produced in Example H1 was subjected to the same procedure as in the aforementioned Examples F6 and G6 to obtain a zinc alloy powder of Example H5.

### Example H6

The zinc alloy powder H produced in Example H1 was subjected to the same procedure as in the aforementioned Examples F7 and G7 to obtain a zinc alloy powder of Example H6.

### Example H7

The zinc alloy powder H produced in Example H1 was subjected to the same procedure as in the aforementioned Examples F8 and G8 to obtain a zinc alloy powder of Example H7.

### Example H8

The zinc alloy powder H produced in Example H1 was subjected to the same procedure as in the aforementioned Examples F9 and G9 to obtain a zinc alloy powder of Example H8.

### Comparative Example H1

The zinc alloy powder H produced in Example H1 was used unchanged.

The characteristics of alkaline manganese dioxide cells using the thus obtained zinc alloy powders of Examples H1 to H8 and Comparative Example H1 as negative electrode active materials were evaluated. The results are shown in Table 9 below.

TABLE 9

| | | | | | Amount of |
|---|---|---|---|---|---|
| | Conditions for treatment | | | | post-discharge |
| | | Heat- | Spherical | | gas |
| | Coating | treatment | powder | KOH | (ml) |
| Ex. H1 | ∘ | — | — | — | 1.05 |
| Ex. H2 | — | — | — | ∘ | 1.20 |
| Ex. H3 | — | ∘ | — | — | 1.19 |
| Ex. H4 | ∘ | ∘ | — | — | 0.83 |
| Ex. H5 | — | ∘ | — | ∘ | 0.95 |
| Ex. H6 | — | — | ∘ | — | 1.35 |
| Ex. H7 | — | ∘ | ∘ | — | 0.95 |
| Ex. H8 | — | — | ∘ | ∘ | 1.08 |
| C. Ex. H1 | — | — | — | — | 1.50 |

Ex. = Example
C. Ex. = Comparative Example

Table 9 shows that in comparison with the alkaline manganese dioxide cell prepared using the zinc alloy powder of Comparative Example H1 as the negative electrode active material, the alkaline manganese dioxide cells prepared using the zinc alloy powders of Examples H1 to H8 as the negative electrode active materials were able to suppress gas generation markedly.

### Example J1

Liquid paraffin in an amount of 2% by weight based on a zinc alloy powder was mixed with a liquid Ja prepared by saturating an aqueous solution of potassium hydroxide having a concentration of 40% by weight with zinc.oxide. In this manner, a liquid Ja was obtained. The zinc alloy powder H prepared in the aforementioned Example H1 was mixed with the liquid Jb to produce a negative electrode of Example J1.

### Example J2

The zinc alloy powder of the aforementioned Example F1 was mixed with the liquid Jb obtained in Example J1 to produce a negative electrode of Example J2.

### Example J3

The zinc alloy powder of the aforementioned Example G1 was mixed with the liquid Jb obtained in Example J1 to produce a negative electrode of Example J3.

### Example J4

The zinc alloy powder of the aforementioned Example H3 was mixed with the liquid Jb obtained in Example J1 to produce a negative electrode of Example J4.

### Example J5

The zinc alloy powder of the aforementioned Example F4 was mixed with the liquid Jb obtained in Example J1 to produce a negative electrode of Example J5.

### Example J6

The zinc alloy powder of the aforementioned Example G4 was mixed with the liquid Jb obtained in Example J1 to produce a negative electrode of Example J6.

### Example J7

The zinc alloy powder of the aforementioned Example H6 was mixed with the liquid Jb obtained in Example J1 to produce a negative electrode of Example J7.

### Example J8

The zinc alloy powder of the aforementioned Example F7 was mixed with the liquid Jb obtained in Example J1 to produce a negative electrode of Example J8.

### Example J9

The zinc alloy powder of the aforementioned Example G7 was mixed with the liquid Jb obtained in Example J1 to produce a negative electrode of Example J9.

### Example J10

The zinc alloy powder H (10 g) prepared in the aforementioned Example H1 was dipped in the aforementioned liquid Ja (5 ml) obtained in Example J1 to prepare a negative electrode. Liquid paraffin in an amount of 2% by weight based on the zinc alloy powder was added to the negative electrode to produce a negative electrode of Example J10.

### Example J11

The zinc alloy powder of the aforementioned Example F1 was used instead of the zinc alloy powder H used in Example J10, thereby producing a negative electrode of Example J11.

### Example J12

The zinc alloy powder of the aforementioned Example G1 was used instead of the zinc alloy powder H used in Example J10, thereby producing a negative electrode of Example J12.

### Example J13

The zinc alloy powder of the aforementioned Example H3 was used instead of the zinc alloy powder H used in Example J10, thereby producing a negative electrode of Example J13.

### Example J14

The zinc alloy powder of the aforementioned Example F4 was used instead of the zinc alloy powder H used in Example J10, thereby producing a negative electrode of Example J14.

### Example J15

The zinc alloy powder of the aforementioned Example G4 was used instead of the zinc alloy powder H used in Example J10, thereby producing a negative electrode of Example J15.

### Example J16

The zinc alloy powder of the aforementioned Example H6 was used instead of the zinc alloy powder H used in Example J10, thereby producing a negative electrode of Example J16.

### Example J17

The zinc alloy powder of the aforementioned Example F7 was used instead of the zinc alloy powder H used in Example J10, thereby producing a negative electrode of Example J17.

### Example J18

The zinc alloy powder of the aforementioned Example G7 was used instead of the zinc alloy powder H used in Example J10, thereby producing a negative electrode of Example J18.

### Comparative Example J1

The zinc alloy powder H prepared in the aforementioned Example H1 was mixed with the liquid Ja obtained in Example J1 to produce a negative electrode of Comparative Example J1.

### Comparative Example J2

The zinc alloy powder of the aforementioned Example F1 was mixed with the liquid Ja obtained in Example J1 to produce a negative electrode of Comparative Example J2.

### Comparative Example J3

The zinc alloy powder of the aforementioned Example G1 was mixed with the liquid Ja obtained in Example J1 to produce a negative electrode of Comparative Example J3.

The characteristics of alkaline manganese dioxide cells using the thus obtained negative electrodes of Examples J1 to J18 and Comparative Examples J1 to J3 were evaluated. The results are shown in Table 10 below. The amounts of gas generation (the amounts of source powder gas generation) by the zinc alloy powders prepared in the respective Examples are also shown.

TABLE 10

| | | | | | |
|---|---|---|---|---|---|
| | | | | Discharge | Amount of |
| Addition of | | | Amount of source | duration | post-dis- |
| liquid | | Conditions for | powder gas | index | charge gas |
| paraffin | Conditions for zinc alloy powder | treatment | (μl/g · d) | (%) | (%) |

| | | | | | | |
|---|---|---|---|---|---|---|
| Ex. J1 | Addition to | Restriction on impurities | None | 4.1 | 105 | 1.05 |
| Ex. J2 | electrolyte | Restriction of particle size | | 6.5 | 110 | 1.30 |
| Ex. J3 | | Restriction on impurities and | | 5.4 | 110 | 1.32 |
| | | particle size | | | | |
| Ex. J4 | | Restriction on impurities | Heat-treatment | 3.2 | 103 | 0.83 |
| Ex. J5 | | Restriction on particle size | | 6.0 | 108 | 0.62 |
| Ex. J6 | | Restriction on impurities and | | 2.0 | 111 | 1.05 |
| | | particle size | | | | |
| Ex. J7 | | Restriction on impurities | Mixing of | 3.9 | 105 | 0.95 |
| Ex. J8 | | Restriction on particle size | spherical | 6.0 | 107 | 0.99 |
| Ex. J9 | | Restriction on impurities and | | 4.0 | 103 | 1.27 |
| | | particle size | | | | |
| Ex. J10 | Addition to | Restriction on impurities | None | 4.4 | 105 | 1.07 |
| Ex. J11 | negative | Restriction on particle size | | 6.2 | 107 | 1.33 |
| Ex. J12 | electrode | Restriction on impurities and | | 5.7 | 110 | 1.31 |
| | | particle size | | | | |
| Ex. J13 | | Restriction on impurities | Heat-treatment | 3.3 | 105 | 0.80 |
| Ex. J14 | | Restriction on particle size | | 6.4 | 105 | 0.65 |
| Ex. J15 | | Restriction on impurities and | | 2.2 | 110 | 1.00 |
| | | particle size | | | | |
| Ex. J16 | | Restriction on impurities | Mixing of | 4.0 | 107 | 0.97 |
| Ex. J17 | | Restriction on particle size | spherical | 6.2 | 107 | 1.00 |
| Ex. J18 | | Restriction on impurities and | powder | 3.8 | 105 | 1.25 |
| | | particle size | | | | |
| C. Ex. J1 | No addition | Restriction on impurities | None | 6.2 | 100 | 1.50 |
| C. Ex. J2 | | Restriction on particle size | | 7.4 | 102 | 1.86 |
| C. Ex. J3 | | Restriction on impurities and | | 6.0 | 106 | 1.51 |
| | | particle size | | | | |

Ex. = Example
C. Ex. = Comparative Example

Table 10 shows that in comparison with the alkaline manganese dioxide cells prepared using the negative electrodes of Comparative Examples J1 to J3, the alkaline manganese dioxide cells prepared using the negative electrodes of Examples J1 to J18 were able to suppress gas generation, and can improve the electrolyte leakage resistance (corrosion resistance) and the high rate characteristics of the cell.

While the present invention has been described in the foregoing fashion, it is to be understood that the invention is not limited thereby, but may be varied in many other ways. Such variations are not to be regarded as a departure from the spirit and scope of the invention, and all such modifications as would be obvious to one skilled in the art are intended to be included within the scope of the appended claims.

What is claimed is:

1. A zinc alloy powder for an alkaline manganese dioxide cell, wherein
an average concentration of an iron component in the zinc alloy powder is 5 ppm or less,
an average concentration of the iron component within a near-surface portion of the zinc alloy powder is 10 ppm or less, and
a total content of the iron component in impurities present at the near-surface portion of the zinc alloy powder is 0.5 ppm or less based on a whole body of particles.

2. The zinc alloy powder for the alkaline manganese dioxide cell according to claim 1, wherein the average concentration of the iron component in the zinc alloy powder exceeds 1 ppm, but is not more than 5 ppm.

3. The zinc alloy powder for the alkaline manganese dioxide cell according to claim 1, which contains 10 to 10,000 ppm each of one or more elements selected from the group consisting of aluminum, bismuth, calcium, indium, lead, magnesium and tin.

4. A zinc alloy powder for an alkaline manganese dioxide cell, wherein
an average concentration of an iron component in the zinc alloy powder is 5 ppm or less,
an average concentration of a Ge component is 20 ppb or less,
an average concentration of an As component is 5 ppb or less, and
an average concentration of an Sb component is 50 ppb or less.

5. A zinc alloy powder for an alkaline manganese dioxide cell, wherein
an average concentration of an iron component in the zinc alloy powder is 5 ppm or less,
an average concentration of a Ge component is 1 ppb or less,
an average concentration of an As component is 5 ppb or less, and
an average concentration of an Sb component is 80 ppb or less.

6. A zinc alloy powder for an alkaline manganese dioxide cell, wherein
an average concentration of an iron component in the zinc alloy powder is 5 ppm or less,
an average concentration of a Ge component is 20 ppb or less,
an average concentration of an As component is 1 ppb or less, and
an average concentration of an Sb component is 70 ppb or less.

7. A zinc alloy powder for an alkaline manganese dioxide cell, wherein
an average concentration of an iron component in the zinc alloy powder is 5 ppm or less,
an average concentration of a Ge component is 27 ppb or less,
an average concentration of an As component is 1 ppb or less, and
an average concentration of an Sb component is 50 ppb or less.

8. A zinc alloy powder for an alkaline manganese dioxide cell, wherein
an average concentration of an iron component in the zinc alloy powder is 5 ppm or less,
an average concentration of a Ge component is 25 ppb or less,
an average concentration of an As component is 5 ppb or less, and
an average concentration of an Sb component is 10 ppb or less.

9. A zinc alloy powder for an alkaline manganese dioxide cell, wherein
an average concentration of an iron component in the zinc alloy powder is 5 ppm or less,
an average concentration of a Ge component is 1 ppb or less,
an average concentration of an As component is 1 ppb or less, and
an average concentration of an Sb component is 110 ppb or less.

10. A zinc alloy powder for an alkaline manganese dioxide cell, wherein
an average concentration of an iron component in the zinc alloy powder is 5 ppm or less,
an average concentration of a Ge component is 29 ppb or less,
an average concentration of an As component is 1 ppb or less, and
an average concentration of an Sb component is 10 ppb or less.

11. A zinc alloy powder for an alkaline manganese dioxide cell, wherein
an average concentration of an iron component in the zinc alloy powder is 5 ppm or less,
an average concentration of a Ge component is 4 ppb or less,
an average concentration of an As component is 1 ppb or less, and
an average concentration of an Sb component is 100 ppb or less.

12. A zinc alloy powder for an alkaline manganese dioxide cell, wherein
an average concentration of an iron component in the zinc alloy powder is 5 ppm or less,
an average concentration of a Ge component is 10 ppb or less,
an average concentration of an As component is 2 ppb or less, and
an average concentration of an Sb component is 90 ppb or less.

13. A zinc alloy powder for an alkaline manganese dioxide cell, wherein
an average concentration of an iron component in the zinc alloy powder is 5 ppm or less,
an average concentration of a Ge component is 5 ppb or less,
an average concentration of an As component is 4 ppb or less, and
an average concentration of an Sb component is 90 ppb or less.

14. The zinc alloy powder for the alkaline manganese dioxide cell according to claim 1, wherein
the average concentration of the Ge component is 20 ppb or less,
the average concentration of the As component is 5 ppb or less, and
the average concentration of the Sb component is 50 ppb or less.

15. The zinc alloy powder for the alkaline manganese dioxide cell according to claim 1, wherein
the average concentration of the Ge component is 1 ppb or less,
the average concentration of the As component is 5 ppb or less, and
the average concentration of the Sb component is 80 ppb or less.

16. The zinc alloy powder for the alkaline manganese dioxide cell according to claim 1, wherein
the average concentration of the Ge component is 20 ppb or less,
the average concentration of the As component is 1 ppb or less, and
the average concentration of the Sb component is 70 ppb or less.

17. The zinc alloy powder for the alkaline manganese dioxide cell according to claim 1, wherein
the average concentration of the Ge component is 27 ppb or less,
the average concentration of the As component is 1 ppb or less, and
the average concentration of the Sb component is 50 ppb or less.

18. The zinc alloy powder for the alkaline manganese dioxide cell according to claim 1, wherein
the average concentration of the Ge component is 25 ppb or less,
the average concentration of the As component is 5 ppb or less, and
the average concentration of the Sb component is 10 ppb or less.

19. The zinc alloy powder for the alkaline manganese dioxide cell according to claim 1, wherein
the average concentration of the Ge component is 1 ppb or less,
the average concentration of the As component is 1 ppb or less, and
the average concentration of the Sb component is 110 ppb or less.

20. The zinc alloy powder for the alkaline manganese dioxide cell according to claim 1, wherein
the average concentration of the Ge component is 29 ppb or less,
the average concentration of the As component is 1 ppb or less, and
the average concentration of the Sb component is 10 ppb or less.

21. The zinc alloy powder for the alkaline manganese dioxide cell according to claim 1, wherein
the average concentration of the Ge component is 4 ppb or less,
the average concentration of the As component is 1 ppb or less, and
the average concentration of the Sb component is 100 ppb or less.

22. The zinc alloy powder for the alkaline manganese dioxide cell according to claim 1, wherein
the average concentration of the Ge component is 10 ppb or less,
the average concentration of the As component is 2 ppb or less, and
the average concentration of the Sb component is 90 ppb or less.

23. The zinc alloy powder for the alkaline manganese dioxide cell according to claim 1, wherein
the average concentration of the Ge component is 5 ppb or less,
the average concentration of the As component is 4 ppb or less, and
the average concentration of the Sb component is 90 ppb or less.

24. A zinc alloy powder for an alkaline manganese dioxide cell, which
contains 10 to 10,000 ppm each of one or more elements selected from the group consisting of aluminum, bismuth, calcium, indium, lead, magnesium and tin, and wherein
a proportion of the zinc alloy powder with a mesh size of 48 to 200 is 90% by weight or more, and a proportion of the zinc alloy powder with a mesh size of −200 is 10% by weight or less.

25. The zinc alloy powder for the alkaline manganese dioxide cell according to claim 24, wherein
an average concentration of an iron component is 5 ppm or less,
an average concentration of a Ge component is 20 ppb or less,
an average concentration of an As component is 5 ppb or less, and
an average concentration of an Sb component is 50 ppb or less.

26. The zinc alloy powder for the alkaline manganese dioxide cell according to claim 24, wherein the proportion of the zinc alloy powder with a mesh size of 80 to 200 is 70% by weight or more.

27. The zinc alloy powder for the alkaline manganese dioxide cell according to claim 4, wherein
a proportion of the zinc alloy powder with a mesh size of −150 is 5 to 50% by weight, and
a proportion of the zinc alloy powder with a mesh size of +150 is 50 to 95% by weight.

28. The zinc alloy powder for the alkaline manganese dioxide cell according to claim 24, wherein
the proportion of the zinc alloy powder with a mesh size of −150 is 5 to 50% by weight, and
the proportion of the zinc alloy powder with a mesh size of +150 is 50 to 95% by weight.

29. The zinc alloy powder for the alkaline manganese dioxide cell according to claim 28, wherein the zinc alloy powder with a mesh size of −150 are spherical.

30. The zinc alloy powder for the alkaline manganese dioxide cell according to claim 28, wherein the zinc alloy powder with a mesh size of −150 have been heat-treated in an inert atmosphere.

31. The zinc alloy powder for the alkaline manganese dioxide cell according to claim 4, which has been treated with an aqueous solution of potassium hydroxide at a concentration of 10 to 60% by weight.

32. The zinc alloy powder for the alkaline manganese dioxide cell according to claim 24, which has been treated with an aqueous solution of potassium hydroxide at a concentration of 10 to 60% by weight.

33. A zinc alloy powder for an alkaline manganese dioxide cell, which
contains 10 to 10,000 ppm each of one or more elements selected from the group consisting of aluminum, bismuth, calcium, indium, lead, magnesium and tin, and which
has been treated with an aqueous solution of potassium hydroxide at a concentration of 10 to 60% by weight.

34. The zinc alloy powder for the alkaline manganese dioxide cell according to claim 4, which has 0.01 to 10% by weight of a liquid saturated hydrocarbon-based oil mixed therewith.

35. The zinc alloy powder for the alkaline manganese dioxide cell according to claim 24, which has 0.01 to 10% by weight of a liquid saturated hydrocarbon-based oil mixed therewith.

36. The zinc alloy powder for the alkaline manganese dioxide cell according to claim 33, which has 0.01 to 10% by weight of a liquid saturated hydrocarbon-based oil mixed therewith.

37. A method for producing a zinc alloy powder for an alkaline manganese dioxide cell, comprising:
adding one or more elements, selected from the group consisting of aluminum, bismuth, calcium, indium, lead, magnesium and tin, in an amount of 10 to 10,000 ppm each to a zinc metal having an average concentration of an iron component of 5 ppm or less;
melting the resulting mixture to form a molten metal; and
atomizing the molten metal to produce the zinc alloy powder according to claim 1.

38. A method for producing a zinc alloy powder for an alkaline manganese dioxide cell, comprising:
adding one or more elements, selected from the group consisting of aluminum, bismuth, calcium, indium, lead, magnesium and tin, in an amount of 10 to 10,000 ppm each to a zinc metal having an average concentration of an iron component of 5 ppm or less;
melting the resulting mixture to form a molten metal; and
atomizing the molten metal to produce the zinc alloy powder according to claim 4.

39. The method for producing the zinc alloy powder for the alkaline manganese dioxide cell according to claim 37, further comprising magnetically separating the zinc alloy powder obtained by atomization.

40. The method for producing the zinc alloy powder for the alkaline manganese dioxide cell according to claim 38, further comprising magnetically separating the zinc alloy powder obtained by atomization.

41. A negative electrode for an alkaline manganese dioxide cell, comprising:
a zinc alloy powder for the alkaline manganese dioxide cell, in which an average concentration of an iron component is 5 ppm or less, an average concentration of a Ge component is 20 ppb or less, an average concentration of an As component is 5 ppb or less, and an average concentration of an Sb component is 50 ppb or less;
a liquid saturated hydrocarbon-based oil in an amount of 0.01 to 10% by weight based on the zinc alloy powder for the alkaline manganese dioxide cell; and
a gelled electrolyte.

42. A negative electrode for an alkaline manganese dioxide cell, comprising:
the zinc alloy powder for the alkaline manganese dioxide cell according to claim 4;
a liquid saturated hydrocarbon-based oil in an amount of 0.01 to 10% by weight based on the zinc alloy powder for the alkaline manganese dioxide cell; and
a gelled electrolyte.

43. A negative electrode for an alkaline manganese dioxide cell, comprising:
the zinc alloy powder for the alkaline manganese dioxide cell according to claim 24;
a liquid saturated hydrocarbon-based oil in an amount of 0.01 to 10% by weight based on the zinc alloy powder for the alkaline manganese dioxide cell; and
a gelled electrolyte.

44. A negative electrode for an alkaline manganese dioxide cell, comprising:
the zinc alloy powder for the alkaline manganese dioxide cell according to claim 33;
a liquid saturated hydrocarbon-based oil in an amount of 0.01 to 10% by weight based on the zinc alloy powder for the alkaline manganese dioxide cell; and
a gelled electrolyte.

45. The negative electrode for the alkaline manganese dioxide cell according to claim 42, wherein the zinc alloy powder for the alkaline manganese dioxide cell has been mixed with the liquid saturated hydrocarbon-based oil.

46. The negative electrode for the alkaline manganese dioxide cell according to claim 43, wherein the zinc alloy powder for the alkaline manganese dioxide cell has been mixed with the liquid saturated hydrocarbon-based oil.

47. The negative electrode for the alkaline manganese dioxide cell according to claim 44, wherein the zinc alloy powder for the alkaline manganese, dioxide cell has been mixed with the liquid saturated hydrocarbon-based oil.

48. The negative electrode for the alkaline manganese dioxide cell according to claim 42, wherein the gelled electrolyte has been mixed with the liquid saturated hydrocarbon-based oil.

49. The negative electrode for the alkaline manganese dioxide cell according to claim 43, wherein the gelled electrolyte has been mixed with the liquid saturated hydrocarbon-based oil.

50. The negative electrode for the alkaline manganese dioxide cell according to claim 44, wherein the gelled electrolyte has been mixed with the liquid saturated hydrocarbon-based oil.

51. An alkaline manganese dioxide cell, which uses the zinc alloy powder for the alkaline manganese dioxide cell according to claim 1 as a negative electrode active material.

52. An alkaline manganese dioxide cell, which uses the zinc alloy powder for the alkaline manganese dioxide cell according to claim 4 as a negative electrode active material.

53. An alkaline manganese dioxide cell, which uses the zinc alloy powder for the alkaline manganese dioxide cell according to claim 24 as a negative electrode active material.

54. An alkaline manganese dioxide cell, which uses the zinc alloy powder for the alkaline manganese dioxide cell according to claim 33 as a negative electrode active material.

55. An alkaline manganese dioxide cell, which has the negative electrode for the alkaline manganese dioxide cell according to claim 41.

56. An alkaline manganese dioxide cell, which has the negative electrode for the alkaline manganese dioxide cell according to claim 42.

57. An alkaline manganese dioxide cell, which has the negative electrode for the alkaline manganese dioxide cell according to claim 43.

58. An alkaline manganese dioxide cell, which has the negative electrode for the alkaline manganese dioxide cell according to claim 44.
